(19) United States
(12) Patent Application Publication
(10) Pub. No.: US 2018/0142777 A1
(43) Pub. Date: May 24, 2018

(54) NON-REVOLVING PUMPING UNIT WITH AUTO-LUBRICATING SPROCKET AND CHAIN

(71) Applicant: Maorong Li, Beijing (CN)

(72) Inventor: Maorong Li, Beijing (CN)

(73) Assignee: FORLAND GROUP INC., HOUSTON, TX (US)

(21) Appl. No.: 15/359,352

(22) Filed: Nov. 22, 2016

(51) Int. Cl. F16H 57/05; F16H 57/04

(52) U.S. Cl. CPC F16H 57/05; F16H 57/045

(57) ABSTRACT

The present invention discloses a non-revolving sprocket-chain structured pumping unit including a auto-lubricating sprocket and a chain, and a pedestal; an oil tank and a driving sprocket are provided on said pedestal; the driving sprocket is immersed into the oil tank at a certain depth; and the oil tank confines a tank-shaped space with a certain amount of a lubricating oil therein; the pumping unit also comprises an oil brush which is attached to the chain.

### CROSS-REFERENCE TO RELATED APPLICATIONS:

The present application claims priority under 35 U.S.C. § 119 to Chinese patent application 201610197568.6, filed Mar. 31, 2016, the disclosure of which is incorporated herein by reference.

### BACKGROUND

### Field of the Invention

The present invention relates to a non-revolving pumping unit with auto-lubricating sprocket and chain, pertaining to the invention of mechanical equipment.

### Background of the Invention

Bottom oil-bath auto-lubricating technology for sprocket and chain of the pumping unit is a matured and extensively applied sprocket and chain lubricating technology, and the technology is characterized with stable and reliable lubrication.

However, when the sprocket and the chain is in interactive rotation or when there is a long distance between the driving and driven sprockets, a challenge will be posed to the above lubricating technology, or the auto-lubricating technology cannot be realized or any lubrication is no longer stable and reliable due to lack of preconditions for the auto-lubricating technology, and the problem will become more serious in the field environment.

Nowadays, the lubricating technology is fully developed; there are various lubricating technologies for the sprocket and the chain, for example, a regular point injecting lubrication, a stamping pump lubrication of bottom oil tank and a regular dry lubricant applying lubrication. However, these technologies have certain applicable preconditions and it is hard to meet the requirements in wild with ever-changing environment and temperature and the large-dosage lubrication requirements for the sprocket and the chain of oil pumping machine. For example, when applying the spot injecting lubrication at stable fixed times, the lubrication for the large-sized sprocket and the chain of pumping unit needs large oil amount, thus the technology cannot meet the requirements for lubrication for large-sized sprocket and chain.

The stamping pump lubrication of bottom oil tank meets the lubricant amount demand of the sprocket and the chain, but the oil pumping machine is a petroleum machine working in wild for an extensive period of time, under normal conditions, the oil supply pump is required to work for hundreds of times every year, so the service life of the oil pump becomes a problem, more importantly, the difference of temperatures between days and nights, especially in winters and summers, is extremely great in the wild, the flow-ability of the lubricant will be affected by the temperature. And the pump transmission, pump suction, conveyance and back flow turn to be the lubrication problems;

The dry lubricant applying technology overcomes the effect of temperature difference but requires regular application, the sprocket and the chain of the oil pumping machine are in closed machine frame, so this technology is difficult to practice under the wild condition.

Therefore, for the past mature lubrication technologies, the lubrication for the sprocket and the chain in wild and closed machine frame leads to difficulties relative to stable and reliable lubrication of non-revolving sprocket and chain.

### SUMMARY OF THE INVENTION

Technical solution of the present invention provides a non-revolving pumping unit with an auto-lubricating sprocket and a chain in regard of the above disadvantages, and is advantageous in realizing a self-lubrication for the chain and the sprocket, while enabling lubricating for large-sized sprocket and chain, as well as lubricating in the field environment.

To solve the technical problem above, the following technical solution will be adopted by the present invention:

A non-revolving pumping unit with an auto-lubricating sprocket and a chain, said pumping unit comprises an non-revolving sprocket and chain auto-lubricating system, which refers to the system for realizing self-lubrication in running status.

Further, said non-revolving sprocket and chain auto-lubricating system comprises an oil tank, a brush and the chain.

Further, said pumping unit also comprises a pedestal which is provided with an oil tank and a driving sprocket.

Further, said driving sprocket is immersed into the oil tank at a certain depth.

Further, said oil tank confines a tank-shaped space with a certain amount of a lubricating oil therein.

Further, said oil brush and the chain are attached to each other.

Further, said pumping unit also comprises a rack, and the oil brush is mounted thereon.

The pumping unit of the present invention has the advantages as follows:

When the sprocket and the chain is operating interactively for a certain period of time, a special lubricating oil in oil tank will be applied level -by -level onto the chain and the chain lubricated with oil runs over and brings lubricant to an upper part of the sprocket, thus to embody a self-lubrication for the non-revolving sprocket and the chain. The self-lubrication for the chain and the sprocket is realized, and lubrication requirements for large-sized sprocket and the chain are met, and the technology is easy to be applied in the field environment.

The present invention will be described in detail hereinafter in connection with the drawings and embodiments.

### BRIEF DESCRIPTION OF THE FIGURES

FIG. 1 is a schematic diagram of the structure of a pumping unit in one embodiment of the present invention;

FIG. 2 is a schematic diagram of the structure of a non-revolving sprocket and chain auto-lubricating system in one embodiment of the present invention;

In the diagram: 1—Motor, 2—Reducer, 3—Driving sprocket, 6—Transition sprocket, 7—Roller, 8—Load belt, 9—Sucker rod, 10—Counter weight box, 11—First driven sprocket, 12—Second driven sprocket, 13—Chain, 14—Oil brush, 15—Oil tank.

### DESCRIPTION OF THE INVENTION

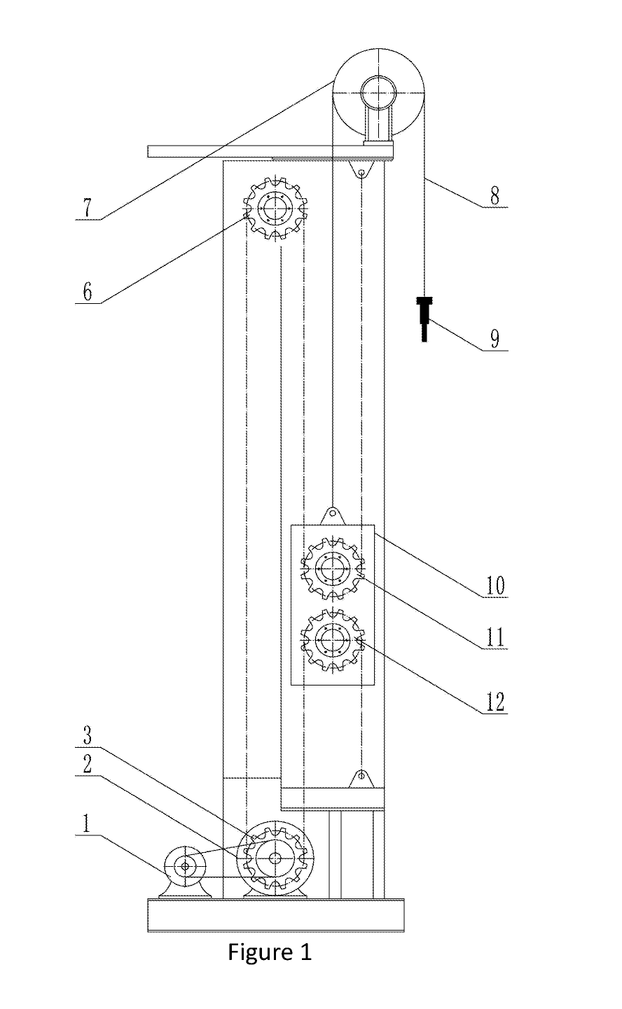

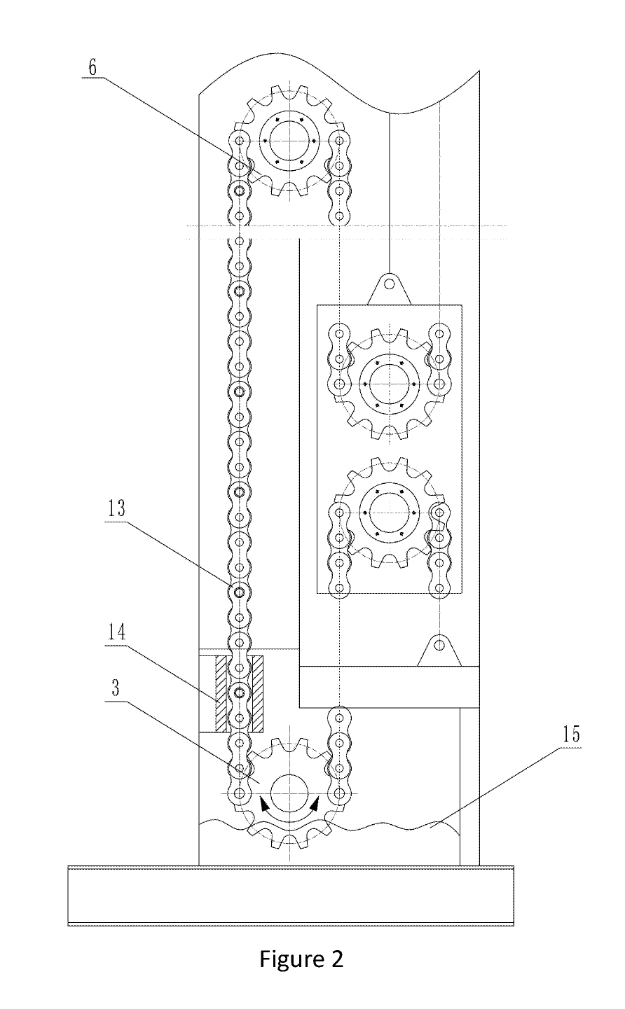

Embodiment 1, as shown in FIG. 1 and FIG. 2, is a non-revolving pumping unit with an auto-lubricating sprocket and a chain, which comprises a pedestal with a motor 1 and a reducer 2 mounted thereon, the motor 1 drives the reducer 2 to rotate through a belt, and a driving sprocket 3 is mounted at an output shaft of the reducer 2.

Said pumping unit also comprises a counter weight box 10; a upper inside end of the counter weight box 10 is provided with a first driven sprocket 11, and a lower inside end of the counter weight box 10 is provided with a second driven sprocket 12 which is connected with the driving sprocket (3) through a chain 13.

Said pumping unit also comprises a rack; a top platform of said rack is provided with a roller 7, and a load belt 8 is winded up around the roller 7, an first end of the load belt 8 is connected with the counter weight box 10, and a second end of the load belt 8 is connected with a sucker rod 9.

A transitional sprocket 6 is installed at the top end of the rack; the transitional sprocket 6 is connected with a driving sprocket 3 and the first driven sprocket 11 through the chain 13.

Said pumping unit also comprises an intelligent control system which is installed in a control cabinet and at a reasonable position nearby motor 1.

Said pumping unit also comprises a non-revolving sprocket and chain auto-lubricating system which comprises an oil tank 15, a brush 14 and the chain 13, and refers to the system for realizing self-lubrication in the running status.

Said oil tank 15 is set on the pedestal, and is a tank-shaped space with a certain amount of a lubricating oil therein; a bottom of the driving sprocket 3 is immersed in the lubricating oil of oil tank 15 at a certain depth.

Said pumping unit also comprises the oil brush 14 which is disposed at the rack, and the oil brush 14 and the chain 13 are attached to each other.

Working mechanism: the driving sprocket rotates which drives the chain into the lubricating oil then out of oil tank, which lubricates a certain length of the chain by the lubricating oil. When the sprocket rotates clockwisely, the chain lubricated by the lubricating oil from the bottom oil tank will move upward from a left side of the sprocket, and will contact the brush wherein the lubricating oil will be transferred to the brush by the inherent viscosity of the lubricating oil.

When the sprocket rotates anti-clockwisely for a certain distance, the lubricating oil on the brush will be applied to an upper part of the chain otherwise not lubricated. The example of the most preferred embodiment of the present invention is described above, in which the parts not detailed therein are commonly known to persons skilled in the art. The scope of protection of the present invention shall be based on the contents of the Claims, and any equivalent transformation based on the technical teachings of the present invention shall fall within the scope of protection of the present invention.

We claim:

1. A non-revolving pumping unit comprises a non-revolving sprocket and chain auto-lubricating system, said non-revolving sprocket and chain auto-lubricating system comprises an oil tank, brush and a chain.

2. The non-revolving pumping unit according to claim 1, further comprises a pedestal which is provided with an oil tank and a driving sprocket.

3. The non-revolving pumping unit according to claim 2, wherein said driving sprocket is immersed into the oil tank at a certain depth.

4. The non-revolving pumping according to claim 2, wherein said oil tank confines a tank-shaped space with a certain amount of lubricating oil therein.

5. The non-revolving pumping unit according to claim 1, wherein: said oil brush and the chain are attached to each other.

6. The non-revolving pumping unit according to claim 1, further comprises a rack, on which the oil brush is mounted.
